(19) United States
(12) Patent Application Publication
(10) Pub. No.: US 2023/0268568 A1
(43) Pub. Date: Aug. 24, 2023

(54) METHODS FOR OPERATING ENERGY STORAGE DEVICES WITH SULFUR-BASED CATHODES, AND RELATED SYSTEMS AND METHODS

(71) Applicant: Battelle Energy Alliance, LLC, Idaho Falls, ID (US)

(72) Inventors: Bin Li, Idaho Falls, ID (US); Eric J. Dufek, Ammon, ID (US); Parameswara R. Chinnam, Idaho Falls, ID (US); Yulun Zhang, Salt Lake City, UT (US)

(21) Appl. No.: 18/005,567

(22) PCT Filed: Jul. 16, 2021
(86) PCT No.: PCT/US21/70888

§ 371 Date: Jan. 13, 2023

Related U.S. Application Data
(60) Provisional application No. 62/705,819, filed on Jul. 16, 2020.

(51) Int. Cl. H01M 10/44; H01M 4/38; H01M 4/62; H01M 10/04

(52) U.S. Cl. CPC H01M 10/44; H01M 4/38; H01M 4/623; H01M 4/625; H01M 10/0481; H01M 2004/021

(57) ABSTRACT

A method of operating an energy storage device comprises applying external pressure onto an electrochemical cell during charging and/or discharging. The cell comprises a sulfur-based cathode within a compressible vessel. An energy storage system may include plates and at least one electrochemical cell that includes—within a compressible vessel—a cathode, an anode, and an electrolyte. The cathode comprises a sulfur-based active material. In a method of assembling a system for operating an energy storage device, at least one electrochemical cell is disposed between a pair of plates and adjacent pressure sensor(s). A distance between the plates is fixed at which a measured pressure is within a range from greater than about 0 kPa to about 689 kPa above ambient pressure. The plate-separation distance is maintained while charging or discharging the electrochemical cell(s).

### CROSS-REFERENCE TO RELATED APPLICATIONS

This application is a national phase entry under 35 U.S.C. § 371 of International Patent Application PCT/US2021/070888, filed Jul. 16, 2021, designating the United States of America and published as International Patent Publication WO 2022/016194 A1 on Jan. 20, 2022, which claims the benefit under Article 8 of the Patent Cooperation Treaty to U.S. Patent Application Ser. No. 62/705,819, filed Jul. 16, 2020.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

Embodiments of the disclosure relate generally to energy storage devices (e.g., batteries, lithium metal batteries, silicon-carbon batteries) and to methods for operating and for forming the energy storage devices. More particularly, embodiments of the disclosure relate to methods for operating energy storage devices that include sulfur-based cathodes. Related energy storage systems and methods of fabrication are also disclosed.

### BACKGROUND

Batteries generally include one or more “cells” (e.g., electrochemical cells) that include electrodes exposed to an electrolyte within an enclosure. The electrodes include an anode and a cathode, both comprising electrically conductive material(s). Through electrochemical interactions (e.g., electrochemical reactions), ions are exchanged between the electrodes through the electrolyte, resulting in chemical energy being converted into electrical energy, which can be used to power devices. Accordingly, rechargeable batteries, such as lithium metal batteries, are widely used throughout the world to power devices like vehicles, portable electronic devices, and optoelectronic devices. However, conventional batteries, such as those used to power electric vehicles, tend to exhibit poor operation parameters, such as low energy density, high cost, and poor cycling (e.g., significant loss of battery capacity as the battery is repeatedly cycled (e.g., charged and discharged)). Therefore, it remains challenging to design, fabricate, and operate metal batteries in a manner that optimizes battery performance parameters, such as battery capacity and battery life.

### BRIEF SUMMARY

In some embodiments, a method of operating an energy storage device comprises, during at least one of charging or discharging of an electrochemical cell of an energy storage device, applying external pressure onto the electrochemical cell. The electrochemical cell comprises a sulfur-based cathode within a compressible vessel.

According to some embodiments, an energy storage system comprises at least one electrochemical cell. The at least one electrochemical cell comprises—within a compressible vessel—a cathode, an anode, a separator, and an electrolyte. The cathode comprises a sulfur-based active material. The separator is between the cathode and the anode. The energy storage system further includes plates configured to be fixed at a distance—separating a first plate of the plates from a second plate of the plates—with the at least one electrochemical cell between the first plate and the second plate to compress the compressible vessel.

Also disclosed is a method of assembling an energy storage system (e.g., a system for operating an energy storage device). The method comprises disposing, between a pair of plates and adjacent at least one pressure sensor, at least one electrochemical cell. The at least one electrochemical cell comprises—within a compressible vessel—a cathode, an anode, a separator, and an electrolyte. The cathode comprises a sulfur-based active material. The separator is between the cathode and the anode. The method further comprises fixing a distance—between the pair of plates—at which a pressure measured by the at least one pressure sensor is within a range from greater than about 0 kPa (about 0 psi) to about 689 kPa (about 100 psi) above ambient pressure. While maintaining the pair of plates at the distance, the at least one electrochemical cell is charged or discharged.

### BRIEF DESCRIPTION OF THE DRAWINGS

FIG. 1A is a top plan, schematic illustration of a cell comprising a sulfur-based cathode, in accordance with embodiments of the disclosure.

FIG. 1B is a side, cross-sectional illustration of the cell of FIG. 1A, taken along section line B-B, in accordance with embodiments of the disclosure.

FIG. 2A is a top plan, schematic illustration of the sulfur-based cathode of the cell of FIG. 1A, in accordance with embodiments of the disclosure.

FIG. 2B is a top plan, schematic illustration of an anode of the cell of FIG. 1A, in accordance with embodiments of the disclosure.

FIG. 2C is a top plan, schematic illustration of a separator of the cell of FIG. 1A, in accordance with embodiments of the disclosure.

FIG. 2D is a top plan, schematic illustration of a pouch of the cell of FIG. 1A, in accordance with embodiments of the disclosure.

FIG. 3A is a top plan, schematic illustration of a cell comprising a sulfur-based cathode, in accordance with embodiments of the disclosure, wherein the cell also comprises a reference electrode.

FIG. 3B is a side, cross-sectional illustration of the cell of FIG. 3A, taken along section line B-B, in accordance with embodiments of the disclosure.

FIG. 4A is a perspective, schematic illustration of a system, in an exploded configuration, for applying external pressure to a cell, such as the cell of FIG. 1A or the cell of FIG. 3A, in accordance with embodiments of the disclosure.

FIG. 4B is a perspective, schematic illustration of the system of FIG. 4A, in a configuration applying an external pressure to the cell, in accordance with embodiments of the disclosure.

FIG. 5A is a chart of potential versus specific capacity for a cell comprising a sulfur-based cathode and lithium metal functioning as an anode, the cell being operated over a number of cycles without application of external pressure.

FIG. 5B is a chart of potential versus specific capacity for a cell comprising a sulfur-based cathode and lithium metal functioning as an anode, the cell being operated over a number of cycles with application of external pressure, in accordance with embodiments of the disclosure.

FIG. 6A is a chart of specific capacity versus cycle number for a cell comprising a sulfur-based cathode and lithium titanate (e.g., Li₄Ti₅O₁₂ (LTO)) functioning as an anode, the cell being operated over a number of cycles both without application of external pressure and with application of external pressure, in accordance with embodiments of the disclosure.

FIG. 6B is a chart of specific capacity versus cycle number for a cell comprising a sulfur-based cathode and a lithium titanium oxide (LTO) anode, both without application of external pressure and with application of external pressure.

FIG. 7A through FIG. 7F are charts of voltage versus discharge (“DC”) and charge (“CC”) capacity at various charge/discharge cycles of a cell comprising a non-calendared sulfur-based cathode and lithium metal functioning as an anode, the cell being operated with varying amounts of externally-applied pressure, in accordance with embodiments of the disclosure, wherein:

FIG. 7A is at a first charge/discharge cycle;

FIG. 7B is at a third charge/discharge cycle;

FIG. 7C is at a tenth charge/discharge cycle;

FIG. 7D is at a twentieth charge/discharge cycle;

FIG. 7E is at a fiftieth charge/discharge cycle; and

FIG. 7F is at a one-hundredth charge/discharge cycle.

FIG. 8A through FIG. 8F are charts of voltage versus discharge (“DC”) and charge (“CC”) capacity at various charge/discharge cycles of a cell comprising a calendared sulfur-based cathode and lithium metal functioning as an anode, the cell being operated with varying amounts of externally-applied pressure, in accordance with embodiments of the disclosure, wherein:

FIG. 8A is at a first charge/discharge cycle;

FIG. 8B is at a third charge/discharge cycle;

FIG. 8C is at a tenth charge/discharge cycle;

FIG. 8D is at a twentieth charge/discharge cycle;

FIG. 8E is at a fiftieth charge/discharge cycle; and

FIG. 8F is at a one-hundredth charge/discharge cycle.

FIG. 9A is a chart of discharge capacity versus cycle number for a cell comprising a sulfur-based cathode and lithium titanate (e.g., Li₄Ti₅O₁₂ (LTO)) functioning as an anode, the cell being operated over a number of cycles both with application of low external pressure (19.7 kPa (2.86 psi)) and with application of moderate external pressure (98.5 kPa (14.3 psi)), in accordance with embodiments of the disclosure.

FIG. 9B is a chart of Coulombic efficiency (“CE”) versus cycle number for a cell comprising a sulfur-based cathode and a lithium titanium oxide (LTO) anode, both with application of low external pressure (19.7 kPa (2.86 psi)) and with application of moderate external pressure (98.5 kPa (14.3 psi)), in accordance with embodiments of the disclosure.

### DETAILED DESCRIPTION

Lithium-sulfur (Li-S) energy devices (e.g., Li-S batteries), in which an anode is lithium-based and a cathode is sulfur-based, have received increasing interest in recent years due to a high theoretical energy capacity (e.g., about 1675 mAh/g) and a low cost of the sulfur-based cathode. The high theoretical energy density of Li-S batteries (e.g., about 2600 Wh/kg, which is about five times greater than that of many conventional lithium-ion batteries), makes Li-S batteries promising candidates for the next generation of energy storage and transportation batteries. However, conventional Li-S batteries tend to suffer from significant capacity fading over cycling due to, e.g., so-called “shuttle effect” (the formation of intermediate polysulfides at the sulfur-based cathode, the dissolution of the intermediate polysulfides in the electrolyte, the migration of the dissolved polysulfides to the lithium-based anode, and then the reaction between the polysulfides and the anode), which can cause “self-discharge” (e.g., loss of chemical energy potential in the electrochemical cell). Conventional Li-S batteries also tend to experience “dead” lithium (e.g., an anode that no longer has actively-available lithium) resulting from the electrochemical reactions occurring during operation of the batteries. For example, lithium dendrites tend to grow at the anode during operation of the Li-S battery, and the dendrites react with the electrolyte(s) of the battery to form solid electrolyte interphases (SEIs) on the surfaces of the dendrites, leading to isolated lithium at the anode. The isolated lithium is effectively inaccessible (e.g., “dead”) for further electrochemical reaction. The dendrite growth can also lead to short circuits and/or structural damage in the components of the battery cell. Moreover, dead lithium is one reason conventional Li-S batteries tend to have poor cycling performance as well as relatively lower energy density. Another reason for the lower energy density of conventional Li-S batteries is the greater amount of electrolyte needed in the cell to ensure sufficient dissolution of intermediate polysulfides during charge and discharge. However, too much electrolyte would lower the energy density of the cell. A higher energy density in Li-S batteries may be preferable.

Disclosed are methods of operating metal batteries (e.g., metal batteries such as lithium (Li), sodium (Na), potassium (K), magnesium (Mg), and/or calcium (Ca) metal batteries; silicon batteries; carbon batteries) that include sulfur-based cathodes. The methods of operation include applying an external pressure to the battery cell during charge and discharge, which external application of pressure enables improved performance parameters, such as higher volumetric energy density, gravimetric energy density, and cycling properties (e.g., capacity performance, Coulombic efficiency).

As used herein, the term “sulfur-based,” when referring to a material or structure, means and includes the material or structure comprising elemental sulfur (S) or a compound that includes at least one sulfur atom (i.e., a “sulfur-including compound”). In some embodiments, “sulfur-based” may also mean the material or structure comprising primarily (e.g., at least about 50 wt. %, at least about 50 vol. %) the element sulfur or the sulfur-including compound.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may,” when used with respect to a material, structure, feature, or method act, indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, even at least 99.9% met, or even 100.0% met.

As used herein, the terms “about” or “approximately,” when used in reference to a numerical value for a particular parameter, are inclusive of the numerical value and a degree of variance from the numerical value that one of ordinary skill in the art would understand is within acceptable tolerances for the particular parameter. For example, “about” or “approximately,” in reference to a numerical value, may include additional numerical values within a range of from 90.0% to 110.0% of the numerical value, such as within a range of from 95.0% to 105.0% of the numerical value, within a range of from 97.5% to 102.5% of the numerical value, within a range of from 99.0% to 101.0% of the numerical value, within a range of from 99.5% to 100.5% of the numerical value, or within a range of from 99.9% to 100.1% of the numerical value.

As used herein, the term “and/or” includes any and all combinations of one or more of the associated listed items.

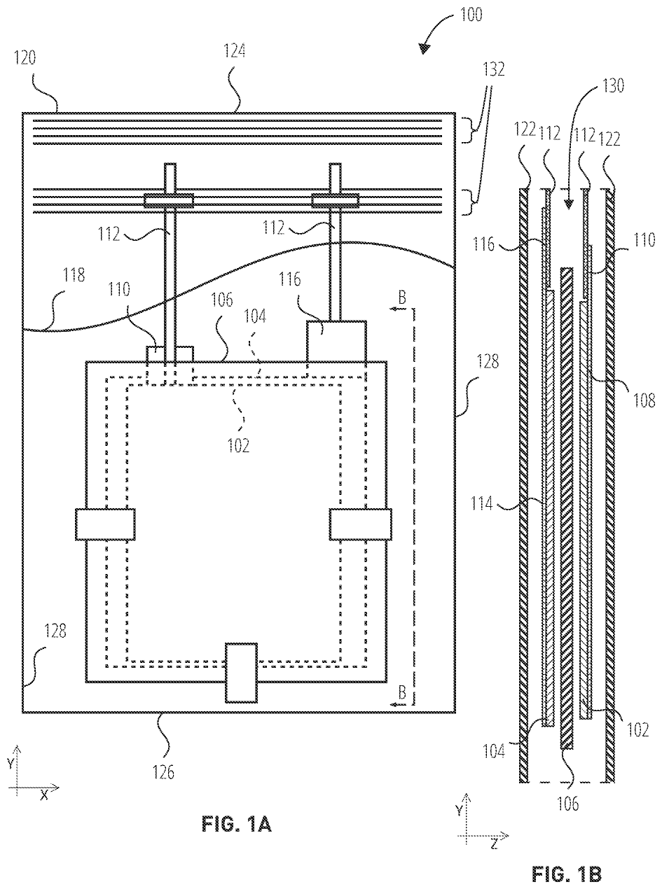

With reference to FIG. 1A and FIG. 1B, illustrated is a cell 100 (e.g., an electrochemical cell) of an electrochemical storage device and/or system, which cell 100 may be structured, fabricated, and operated according to embodiments of the present disclosure. FIG. 1A illustrates a top plan view, which may equivalently represent a bottom plan view in that the cell 100 could be flipped over and still be operable in the same manner as described below. FIG. 1B is a partial cross-sectional illustration of the cell 100 of FIG. 1A, taken along section line B-B.

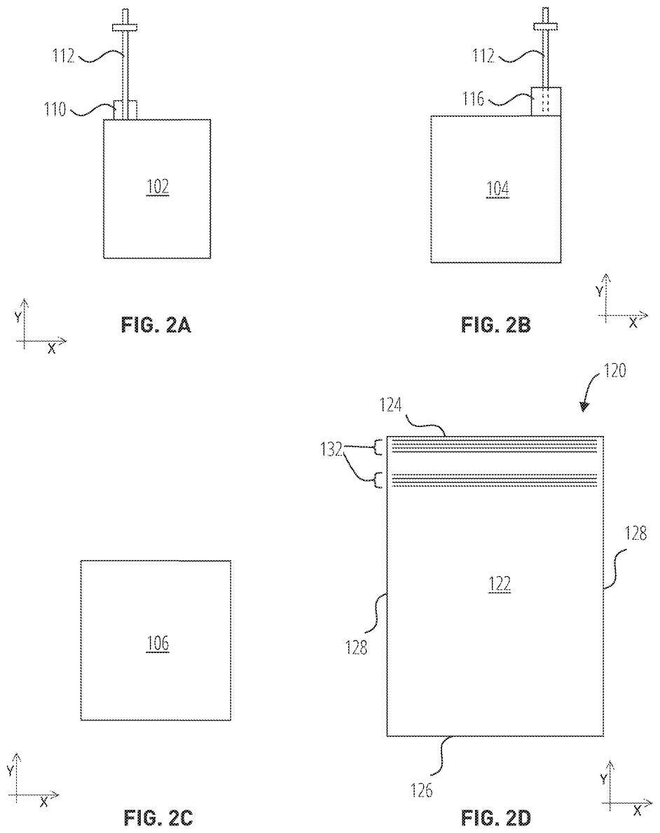

The cell 100 includes a cathode 102 (further illustrated in FIG. 2A), an anode 104 (further illustrated in FIG. 2B), and a separator 106 (further illustrated in FIG. 2C) between the cathode 102 and the anode 104. The cathode 102 may be smaller, in top and bottom cross-sectional area than the anode 104. The separator 106 may be larger, in top and bottom cross-sectional area, than both the cathode 102 and the anode 104.

The cathode 102 comprises an active material that is sulfur-based. Therefore, the cathode 102 and the active material thereof includes or is primarily sulfur, and the sulfur may function as a so-called “active species” of the cathode 102. The active material may be the primary component of the cathode 102. For example, the active material (e.g., sulfur) may constitute at least about 50 wt. % and/or at least about 50 vol. % of the cathode 102. The cathode 102 further comprises at least one electrically-conductive material, which may be chemically compounded with the sulfur of the active material or may be a material in addition to the sulfur-based active material. In some embodiments in which the electrically-conductive material(s) is not chemically compounded with the sulfur-based active material, the electrically-conductive material(s) may be configured as so-called “host material(s)” providing structural support to the sulfur-based active material. For example, the host material(s) may comprise an electrically-conductive material that is also porous or otherwise exhibits a relatively-high surface area. Such a host material may be formed of and include porous carbon, other high-surface-area carbon, high-surface-area metal(s), a porous metal sulfide, a porous metal oxide, electrically-conducting polymer(s). Prior to use of the cathode 102, the sulfur-based active material may be disposed on (e.g., on a surface of) or in (e.g., within pores of) the host material(s). In some embodiments, the cathode 102 may include more than one electrically-conductive material as the host material(s) to the sulfur-based active-material.

In some embodiments, the at least one electrically-conductive material comprises a superconductive species (e.g., a superconductive carbon species, such as nanocarbon material (e.g., a carbon-nanotube-based material, such as SUPER P®), which is a conductive nanocarbon-based material commercially available from Alfa Aesar of Tewksbury, Mass.). The inclusion of the superconductive species may ensure the cathode 102 exhibits sufficient electrical conductivity. In embodiments in which the host material(s) are sufficient alone to ensure adequate electrical conductivity of the cathode 102, the superconductive species may be omitted.

If included, the superconductive species may be in addition to other electrically conductive material(s) functioning as the host material(s), or the superconductive species may itself function as the, or one of the, host material(s). Therefore, in embodiments including host material(s) and superconductive species, the host material(s) and the superconductive species may be the same, single material or may include different materials within the cathode 102.

For example, in some embodiments, the active material of the cathode 102 comprises, consists essentially of, or consists of elemental sulfur and/or a sulfur compound, and the cathode 102 further comprises at least one porous and electrically-conductive (e.g., carbon-based) host material with the elemental sulfur and/or sulfur compound within pores of the host material(s). This cathode 102 may further comprise the superconductive species described above.

As another example, in embodiments in which the electrically-conductive material is chemically compounded with the sulfur of the active-material, the compounded electrically-conductive material may comprise, consist essentially of, or consist of carbon, and the sulfur compound may comprise sulfur-carbon (S—C) chemical bonds. For example, the cathode 102 may comprise sulfurized polyacrylonitrile (SPAN), the SPAN providing both the sulfur-based material and an electrically-conductive material of the cathode 102. This cathode 102 may further comprise the superconductive species described above.

In any of the aforementioned embodiments, the cathode 102 may further include one or more binders. The binder(s), if included in the cathode 102, may include, for example, a polymer material, such as a polyvinylidene (e.g., polyvinylidene fluoride (PVDF), polyvinylidene difluoride (—(C₂H₂F₂)ₙ—)). The binder(s), if included in the cathode 102, serve to interconnect other component(s) or material(s) of the cathode 102, such as one or more of the sulfur-based active material(s), of the electrically-conductive material(s), and/or other material(s). In some such embodiments, the binder(s) may interconnect host materials to provide a supportive matrix for the active material of the cathode 102. For example, in embodiments in which the host material(s) is(are) porous, the active material (e.g., sulfur) may be present within the pores of the host material(s), and the binder(s)—if included—may promote the interconnection between the host material(s), the active material, or any combination thereof.

For example, and without limitation, in some embodiments, the cathode 102 comprises, consists essentially of, or consists of about 60 wt. % active species (e.g., about 60 wt. % sulfur, such as elemental sulfur), about 30 wt. % electrically-conductive material (e.g., about 30 wt. % SUPER P®, a superconductive species functioning as the host material), and about 10 wt. % binder(s) (e.g., about 10 wt. % PVDF), wherein the percentages are based on the weight of the cathode 102 or on the weight of the mixture of the active species, the electrically-conductive material, and the binder.

As another example, and without limitation, in some embodiments, the cathode 102 comprises, consists essentially of, or consists of about 80 wt. % SPAN (e.g., providing the active material in the form of a sulfur active species chemically compounded with an electrically-conductive material, including sulfur-carbon (S—C) bonds), about 10 wt. % superconductive species (e.g., SUPER P®), and about 10 wt. % binder(s) (e.g., PVDF), wherein the percentages are based on the weight of the cathode 102 or on the weight of the mixture of the SPAN, the superconductive species, and the binder(s). Such cathode 102 may not include an additional electrically-conductive host material because the sulfur-compound SPAN material may already provide sufficient support for the sulfur active species.

To fabricate the cathode 102, a slurry may be formed as a mixture (e.g., a solution) of the active material, the electrically-conductive agent(s) (e.g., the host material(s) and the superconductive species, if included), and the binder (if included), all dissolved in a solvent (e.g., N-methyl-2-pyrrolidinone (NMP)). The components of the slurry may be added in any sequence or combination. In embodiments including sulfur compounded with an electrically-conductive material, the sulfur compound may be formed before the sulfur compound is included in the slurry with any other active material(s), electrically-conductive material(s), the binder(s), and the solvent. In other such embodiments, the sulfur compound may be formed in situ within the slurry.

The slurry constitutes a “precursor” material from which the cathode 102 is formed, which slurry (e.g., precursor material) comprises a mixture of the active material, the electrically-conductive material(s) (e.g., the host material(s) the superconductive species, if included), and the binder(s) (if included).

The slurry is then coated on a cathode support material 108 (e.g., a relatively thin film of conductive material(s), such as a carbon-coated aluminum foil). Then, the solvent is evaporated (e.g., by disposing the slurry-coated, cathode support material 108 in a vacuum environment for a sufficient period of time to enable the solvent to substantially fully evaporate). Once the solvent is substantially evaporated, the remaining materials constitute the cathode 102, disposed on a surface of the cathode support material 108.

In some embodiments, the cathode 102 may be calendared to alter (e.g., lower) the porosity exhibited by the cathode 102, such as to lower the porosity (e.g., increase the density) to less than about 60 vol. % porosity. In other embodiments, the cathode 102 may not be calendared. The porosity exhibited by such a non-calendared cathode 102 may be relatively-high, such as greater than about 80 vol. % (e.g., from about 80 vol. % to about 90 vol. %).

Whether the cathode 102 is calendared or non-calendared, the e cathode support material 108 may be cut to approximately the same size and shape as the cathode 102, but with a portion of the cathode support material 108 extending laterally beyond the cathode 102. This extending portion provides a tab 110 to which a conductive lead 112 may be joined for electrical communication from and to the cathode 102 during operation of the cell 100. This assembly of cathode 102 and cathode support material 108 is further illustrated in FIG. 2A.

The anode 104 of the cell 100 may comprise, consist essentially of, or consist of one or more metals (e.g., lithium (Li), sodium (Na), potassium (K), magnesium (Mg), calcium (Ca)), carbon, or a combination of silicon and carbon. For example, in some embodiments, the material of the anode 104 may comprise, consist essentially of, or consist of one or more of lithium metal, lithiated graphite, lithiated graphene, lithiated hard carbon, silicon carbon, or silicon nanowire comprising carbon.

Like the formation of the cathode 102, the anode 104 may be formed by coating a slurry—comprising the material of the anode 104 dissolved in a solvent (e.g., NMP)—on an anode support material 114 and allowing the solvent to dissolve. For example, the anode support material 114 may include a relatively thin film of conductive material (e.g., nickel film). Once the solvent is evaporated, the anode support material 114 may be cut to substantially the same size and shape as the anode 104, but with a portion of the anode support material 114 extending laterally beyond the anode 104. This extending portion provides a tab 116 to which another of the conductive leads 112 may be joined for electrically communication from and to the anode 104 during operation of the cell 100. This assembly of anode 104 and anode support material 114 is further illustrated in FIG. 2B.

In the cell 100, the separator 106 is disposed between the cathode 102 and the anode 104 to prevent internal short-circuiting. The separator 106 may be a porous structure (e.g., a membrane, a nonwoven mat, multilayers of any thereof), which provides a path for ionic conduction between the anode 104 and the cathode 102, and through an electrolyte 118, throughout the interconnected porous structure of the separator 106 itself.

The separator 106 (further illustrated in FIG. 2C) may comprise, consist essentially of, or consist of a polymer. For example, the separator 106 may comprise, consist essentially of, or consist of one or more of polyethylene, polypropylene, polyethylene terephthalate, ultrahigh molecular weight polyethylene (UHMWPE), or polyolefin. Such polymer-based materials for the separator 106 may further include polymers (e.g., any one or more of the aforementioned polymer-based separators) that also comprise a ceramic filling (e.g., ceramic-filled polyolefin, ceramic-filled UHMWPE).

The electrolyte 118 of the cell 100 may include, first, one or more of poly(ethylene glycol) dimethyl ether (PEGDME), tetraethylene glycol dimethyl ether (TEGDME), 1,3-dioxolane (DOL), dimethoxyethane (DME), or diethylene glycol dimethyl ether (DEGDME); and, second, one or more of lithium bis(trifluoromethanesulfonyl)imide (LiTFSI), lithium nitrate (LiNO₃), vanillylmandelic acid (vMA), lithium triflate (LiOTf), lithium perchlorate (LiClO₄), lithium bis(trifluoromethanesulfonyl)azanide (LiTFSA), N-butyl-N-methylpyrrolidinium Bis(trifluoromethanesulfonyl)imide (P₁₄TFSI), or tetrabutylammonium trifluoromethanesulfonate (TBAOTf). For example, in some embodiments, the electrolyte 118 may be selected to comprise, consist essentially of, or consist of PEGDME and LiTFSI; TEGDME and LiTFSI; TEGDME, DOL, and LiTFSI; TEGDME, DOL, LiTFSI, and LiNO₃; TEGDME, DOL, vMA, and LiTFSI; TEGDME, DOL, and LiOTf; TEGDME, DOL, and LiClO₄; TEGDME and LiTFSA; DOL and LiTFSI; DOL, DME, and LiClO₄; DOL, DME, LiTFSI, and LiNO₃; DOL, DME, and LiOTf; DOL, DME, and LiTFSI; DOL, DME, LiTFSI, and P₁₄TFSI; DOL, DME, LiNO₃, and P₁₄TFSI; DOL, DME, LiNO₃, and TBAOTf; or DME, DEGDME, and LiOTf. Accordingly, the electrolyte 118 may comprise a liquid electrolyte. In other embodiments, the electrolyte 118 of the cell 100 may comprise a solid electrolyte, such as a solid ceramic electrolyte and/or a solid polymer electrolyte with high ionic conductivity.

The cell 100 further includes a vessel (e.g., a pouch 120, further illustrated in FIG. 2D). The pouch 120 is at least partially compressible (e.g., a compressible vessel). In some embodiments, the pouch 120 may be formed of flexible material(s) in the form of two or more panels 122, which may be joined, sealed, or otherwise connected along an upper edge 124, a lower edge 126, and side edges 128 of the pouch 120. The pouch 120 defines an interior space 130 in which the cathode 102, the anode 104, the separator 106, and the electrolyte 118 are disposed. In some embodiments, the cathode 102 and the anode 104 may be disposed directly adjacent the separator 106, without a gap between the cathode 102 and the separator 106 or between the anode 104 and the separator 106. In other embodiments, a gap may space each of the cathode 102 and the anode 104 from the separator 106, and the electrolyte 118 may fill the gaps.

In some embodiments, the cathode 102 and the anode 104 may be disposed in the pouch 120 and about the separator 106 (e.g., with the separator 106 disposed between the cathode 102 and the anode 104) so that the cathode support material 108 and the anode support material 114 are the outer surfaces of the stack of cathode 102, anode 104, and separator 106 and such that the cathode 102 material(s) and the anode 104 material(s) face, or directly interface with, the separator 106.

The pouch 120 is sealed in a manner that the leads 112 extend from their respective one of the tab 110 and the tab 116, through one of the panels 122 (e.g., a top one of the panels 122) so that electrical connections can be made to the leads 112 and, effectively, to the cathode 102 and the anode 104.

The pouch 120 may further include sealed portions 132 along the upper edge 124 and along the portion of the cell 100 at which the leads 112 extend out from the interior space 130 of the pouch 120.

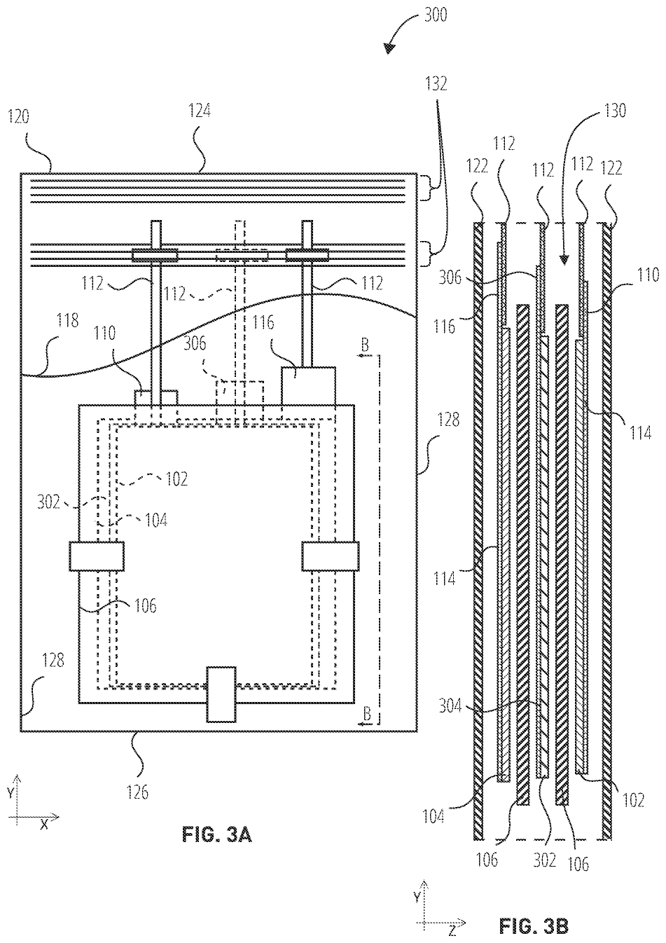

With reference to FIG. 3A and FIG. 3B, in some embodiments, a cell 300 may include not only the components, materials, and constructions discussed above with respect to the cell 100 of FIG. 1A, FIG. 1B, and FIG. 2A through FIG. 2D, but also a reference electrode 302. The reference electrode 302 may also be formed and supported by a reference electrode support material 304, a portion of which may laterally extend to provide a tab 306 for attachment of another one of the leads 112. The reference electrode 302 may be disposed between a pair of the separators 106.

According to disclosed embodiments for operating an energy storage device (e.g., battery) that includes a cell assembly (e.g., the cell 100 of FIG. 1A and FIG. 1B, the cell 300 of FIG. 3A and FIG. 3B), pressure is applied onto the cell 100 (or the cell 300) during cycling (e.g., charging and discharging). For example, the pressure may be applied to the whole of the cell 100 (or the cell 300) from outside the cell 100 onto at least one surface of the compressible vessel (e.g., the pouch 120. For example, pressure (e.g., weight) may be applied onto one or both of the panels 122 (FIG. 1A, FIG. 1B, FIG. 3A, FIG. 3B)). As used herein, reference to “applying external pressure,” “applying pressure externally,” or the like, mean and include, without limitation, applying an external compressive force to the cell, e.g., mechanically, such as by physical compression of the cell by one or more external physical apparatus, by physical compression of the cell by one or more external materials (e.g., by immersing the cell at least partially in a fluid, such as a liquid or a gas, exhibiting a pressure above at least an initial internal pressure within the cell), or another external environment change that exhibits a compressive force onto the cell to effectively raise the internal pressure within the cell.

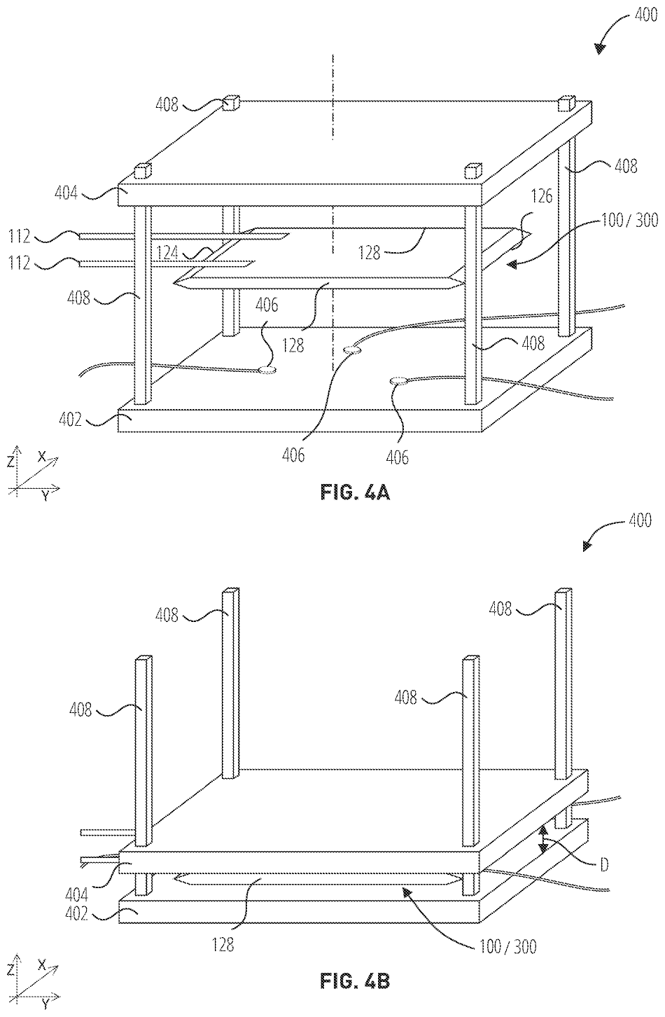

With reference to FIG. 4A and FIG. 4B, the pressure may be applied by inserting the cell assembly (e.g., the cell 100, the cell 300) between plates (e.g., a pair of plates) of a system 400 (e.g., between a base plate 402 and an upper plate 404). At least one of the plates (e.g., the upper plate 404) is movable (e.g., along one or more supports 408) relative to the other of the plates (e.g., the base plate 402) to adjust the distance between the two plates.

In some embodiments, each plate may be in a form of a solid, monolithic, planar structure. However, the disclosure is not so limited. In other embodiments, the plates may be otherwise structured and yet still be configured to selectively apply a compressible mechanical force onto the pouch 120 (FIG. 1A, FIG. 3A) of the cell assembly (e.g., the cell 100, the cell 300). For example, any of the plates may be in one or more parts with at least one of the plates adjustable, relative to at least one other of the plates, to at least partially compress the cell assembly (e.g., the cell 100, the cell 300). Therefore, the upper plate 404 and/or the base plate 402 illustrated in the figures may represent more than one singular structure portion.

In some embodiments, only one plate (e.g., the upper plate 404) may be included above and only one plate (e.g., the base plate 402) may be included below the cell assembly (e.g., the cell 100, the cell 300), as illustrated in FIG. 4A and FIG. 4B. In other embodiments, one or more additional plates may be included above, below, or otherwise adjacent the cell assembly (e.g., the cell 100, the cell 300). These additional plate(s) may or may be directly contactable with one or more of the other plates (e.g., the base plate 402, the upper plate 404) and/or with the cell assembly (e.g., the cell 100, the cell 300).

In some embodiments, one or more of the plates (e.g., the upper plate 404, the base plate 402) may be structured to be larger and extend beyond the peripheral edges of the cell assembly (e.g., the cell 100, the cell 300), as illustrated in FIGS. 4A and 4B, so that substantially a whole of a surface of the cell assembly is contactable by the plates. However, the disclosure is not so limited. In other embodiments, any of the plates may be configured to be smaller than, and contact only a portion of a surface of, the cell assembly (e.g., the cell 100, the cell 300).

Though the figures illustrate the plates being vertically above and below the cell assembly (e.g., the cell 100, the cell 300), the disclosure is not so limited. For example, in other embodiments, the plates may be horizontally adjacent the cell assembly (e.g., the cell 100, the cell 300) and configured to be moved to horizontally compress the cell assembly (e.g., the cell 100, the cell 300). In still other embodiments, the plates may be positioned and configured to apply both a vertical and a horizontal compressive stress, such as by including horizontally-adjacent plates in addition to vertically-adjacent plates (e.g., the base plate 402 and the upper plate 404).

One or more pressure sensors 406 may also be positioned between at least one of the plates (e.g., the base plate 402, the upper plate 404) and the cell assembly (e.g., the cell 100, the cell 300) and configured to measure the externally applied pressure. Additionally or alternatively, one or more pressure transducers may be included within the pouch 120 (FIG. 1A, FIG. 3A) itself and configured to measure the internal pressure of the cell assembly (e.g., the cell 100, the cell 300).

With the cell assembly (e.g., the cell 100, the cell 300) between the plates, the plates (e.g., the upper plate 404 and the base plate 402) may be positioned, relative to one another, to define a distance D that may remain fixed during operation of the cell assembly (e.g., the cell 100, the cell 300). In this configuration, the upper plate 404 and the base plate 402 effectively apply an external pressure onto the cell assembly (e.g., the cell 100, the cell 300), which pressure may be measured by the pressure sensors 406. Using the measurements from the pressure sensors 406, the distance D may be selected to tailor the pressure on the cell assembly (e.g., the cell 100, the cell 300). In some embodiments, a load (e.g., weights) may be added onto the upper plate 404 to further tailor the pressure externally applied.

In some embodiments, the external pressure applied to the cell assembly (e.g., the cell 100, the cell 300), at least before initiating charging or discharging of the cell, may in a range from greater than about 0 kPa (about 0 psi) to about 689 kPa (about 100 psi) above ambient pressure, such as about 6.9 kPa (about 1 psi), about 7.9 kPa (about 1.1 psi), about 13.8 kPa (about 2 psi), about 19.7 kPa (about 2.86 psi), about 34.4 kPa (about 5 psi), about 39.4 kPa (about 5.71 psi), about 98.5 kPa (about 14.3 psi), about 172 kPa (about 25 psi), about 197 kPa (about 28.6 psi), or greater, above ambient pressure and/or above an initial, internal pressure of the cell (e.g., an internal pressure within the pouch 120 (FIG. 1A, FIG. 3A) prior to vacuum sealing the pouch 120).

With the distance D separating the base plate 402 and the upper plate 404 fixed—and therefore, with the externally-applied pressure fixed—the cell assembly (e.g., the cell 100, the cell 300) is then operated to charge and/or discharge the cell. During such cycling, there is likely to be a change of pressure within the cell, as a result of the ongoing electrochemical reaction. For example, during charging, lithium plating (e.g., in embodiments in which the anode 104 (FIG. 1A, FIG. 3A) comprises lithium metal) may increase the pressure within the pouch 120 (FIG. 1A, FIG. 3A). Moreover, at the cathode 102 side, solid sulfur will convert to liquid polysulfide or solid lithium sulfide, which also leads to a change of internal pressure in the pouch 120. Accordingly, while the distance D may remain fixed during operation, the pressure measured by the pressure sensors 406 may increase.

Application of the external pressure during operation of the cell assembly (e.g., the cell 100, the cell 300) enables several improvements in performance parameters, including enabling a greater energy density of the cell. For example, the cathode 102 may be formed (e.g., calendared or not calendared) with a porosity tailored according to the external pressure to be applied during operation. During operation, and as conditions within the cell assembly (e.g., the cell 100, the cell 300) change, the porosity of the cathode 102 material may change, but the initial porosity of the cathode 102 may be selected and tailored to optimize cathode 102 performance under the application of the external pressure. More particularly, by tailoring and optimizing the porosity of the cathode 102, the amount of active material (e.g., sulfur) available in the cathode 102 may be tailored and optimized.

In some embodiments, the cathode 102 may be formed, and the materials thereof selected, so that the initial porosity of the cathode 102 (e.g., the porosity of the cathode 102 prior to application of the external pressure and prior to operation of the cell 100 or the cell 300) may be between about 10 vol. % and about 90 vol. % porous (e.g., between about 30 vol. % and about 90 vol. % porous). In some such embodiments, the cathode 102 may be formed as a calendared cathode, and the porosity may be less than about 60 vol. % (e.g., between about 10 vol. % and about 60 vol. %, about 50 vol. %, about 40 vol. %, etc.). In other embodiments, the cathode 102 may be formed as a non-calendared cathode, and the porosity may be greater than about 80 vol. % (e.g., between about 80 vol. % and about 90 vol. %). In tailoring the initial porosity, the porosity may be tailored so as to be not so high as to take on too much of the electrolyte 118 during operation, which would result in the energy density of the cell being less than it could otherwise be, as well as not so low as to limit the diffusion of ions from the cathode 102, which may lead to higher electrical resistance of the cathode 102.

The initial pressure externally applied may also be selected and tailored according to the porosity of the cathode 102. For example, in embodiments utilizing a calendared cathode 102 with a porosity of less than about 60 vol. %, the initial externally-applied pressure may be selected to be a moderate pressure (e.g., not exceeding about 98.5 kPa (about 14.3 psi)) for efficient performance of the cell (e.g., the cell 100, the cell 300). As another example, in embodiments utilizing a non-calendared cathode 102 with a porosity of at least about 80 vol. %, the initial externally-applied pressure may be selected to be any of a low, moderate, or high pressure (e.g., within a range from greater than about 0 kPa (about 0 psi) to about 197 kPa (about 28.6 psi), such as any of the pressures discussed above).

Application of the external pressure also increases physical interconnection between the materials of the cathode 102. For example, applying the external pressure may increase the physical contact between the electrically-conductive (e.g., host) material(s) and the active material (e.g., the sulfur) or between electrically-conductive host materials. For example, when the cathode 102 is subjected to a higher pressure (e.g., by virtue of subjecting the cell assembly (e.g., the cell 100, the cell 300) to an externally applied pressure), the materials of which the cathode 102 is composed are also effectively pressed closer together, producing closer physical contact between the materials themselves. This increased interconnection may decrease the electrical resistance of the cathode 102. That is, the increased interconnection due to the increased pressure may increase the electrical conductivity of the cathode 102, which may increase the electrical performance of the cathode 102 during operation of the cell assembly (e.g., the cell 100, the cell 300).

Moreover, with increased contact between the materials of the cathode 102, the cathode 102 may require less, if any, binder material relative to the other materials of the cathode 102, including relative to the active material (e.g., the sulfur). With less or no binder, a higher volume and weight percentage of the cathode 102 may be occupied by the active material and the electrically-conductive material(s) (e.g., the host material(s) and the superconductive species, if included), which results in a higher volumetric and gravimetric energy density of the cell (e.g., the cell 100, the cell 300).

The application of the external pressure during operation of the cell 100 (e.g., the cell 100, the cell 300) also inhibits volumetric changes of the components of the cell (e.g., the cell 100, the cell 300) itself. For example, without an externally-applied pressure during operation of the cell (e.g., the cell 100, the cell 300), the active material of the cathode 102 (e.g., the sulfur) may increase in volume. However, with the external application of pressure, the volume increase of the active material may be inhibited. This may prevent cracking of the cathode 102 or other components of the cell (e.g., the cell 100, the cell 300). Thus, the external application of pressure may also avoid damage to the cell (e.g., the cell 100, the cell 300).

External application of pressure also inhibits the dendrite growth at the anode 104 side due to soft lithium (or other anode 104 material) that may otherwise cause damage to the components of the cell (e.g., the cell 100, the cell 300) during charging processes. Inhibiting dendrite growth also prevents “dead” lithium (or other anode 104 material). In addition, external application of pressure may minimize cracking of the cathode 102. For example, during discharging of the cell (e.g., the cell 100, the cell 300), sulfur is lithiated (e.g., in embodiments in which the anode 104 comprises lithium) at the cathode 102, and it may generate lithium sulfides or lithium polysulfides that can cause volume change, in the absence of externally-applied pressure, by forming cracks in the cathode 102. With the external application of pressure, dendrite growth and dead lithium at the anode 104 may be inhibited, and cracking at the cathode 102 due to volume change may be avoided, increasing cell effectiveness, cycling performance, Coulombic efficiency, and battery lifetime.

Accordingly, the external application of pressure onto the cell (e.g., the cell 100, the cell 300) during operation of the cell improves the performance of the cell. Further, tailoring of the porosity of the cathode 102 (e.g., by calendaring or not calendaring the material of the cathode 102) may also improve the performance of the cell. Moreover, as demonstrated by the examples discussed below, the performance improvements are the result of improvements exhibited by the cathode 102 itself, rather than only by the anode 104.

### EXAMPLES

In Examples 1 to 3, below, the subject cell is in accordance with the cell 100 of FIG. 1A and FIG. 1B, wherein the cathode 102 comprised 60 wt. % sulfur (active material), 30 wt. % SUPER P® (host material, or both host material and superconductive species), and 10 wt. % PVDF (binder).

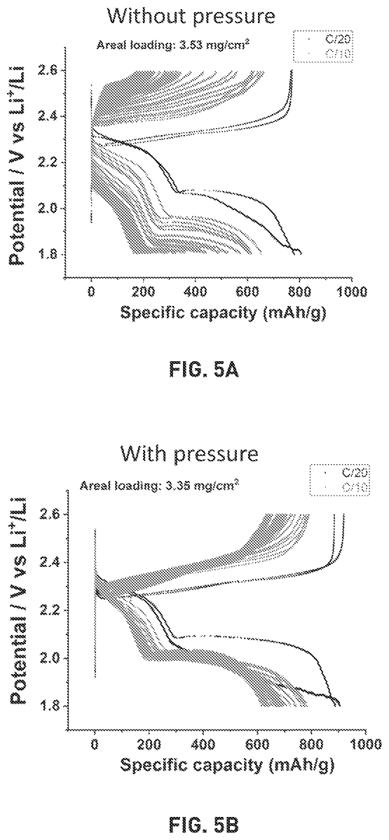

Example 1: Without applying external pressure to the cell 100, aside from ambient (room) pressure, FIG. 5A shows measured potential versus specific capacity over cycling, for both a battery charge or discharge rate of C/10 (“C/10” indicating the cell 100 is supposed to be fully charged or discharged over a period of 10 hours) and a battery charge or discharge rate of C/20 (“C/20” indicating the cell 100 is supposed to be fully charged or discharged over a period of 20 hours).

Example 2: After applying an initial external pressure to the cell 100 of about 172 kPa (about 25 psi), using the system 400 of FIG. 4A and FIG. 4B and leaving—during operation—the plates at the distance D at which the initial pressure of about 172 kPa (about 25 psi) was measured by the pressure sensors 406, FIG. 5B shows measured potential versus specific capacity over cycling, again for both C/10 and C/20.

Comparing FIG. 5A to FIG. 5B, it can be seen that the application of the external pressure generally increases the specific capacity exhibited by the cell 100.

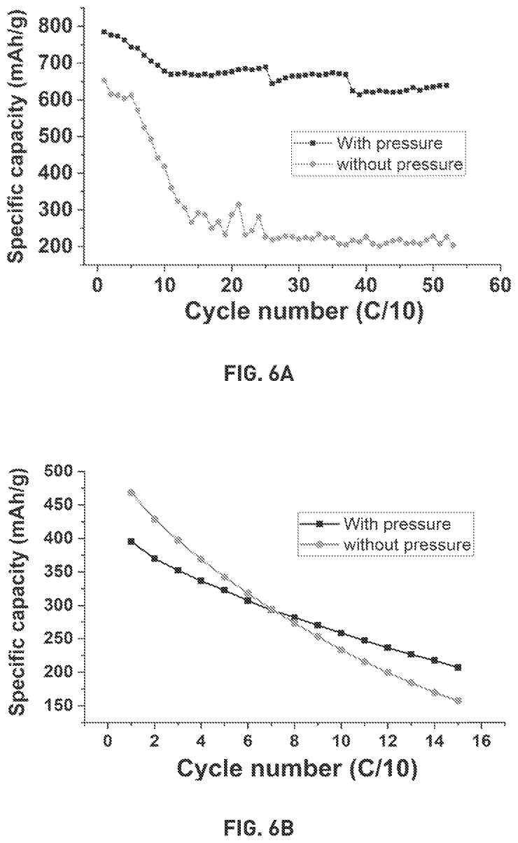

Example 3: FIG. 6A charts, for comparison, the specific capacity against cycle number of the cell 100 for both cycling without pressure (e.g., as in Example 1) and with application of the external pressure (e.g., as in Example 2). Notably, the cell 100 exhibits significantly greater specific capacity over the fifty charted cycles, compared to the specific capacity exhibited without external pressure applied.

Example 4: FIG. 6B charts the specific capacity versus cycle number for a LTO-S pouch cell, wherein the cathode 102 comprises sulfur as the active material, while an anode (e.g., the anode 104) is formed of lithium titanium oxide (e.g., Li₄Ti₅O₁₂ (LTO)). With an LTO anode, dendrite growth is not a concern or factor in the operation of the LTO-S pouch cell. Accordingly, any difference in performance observed between applying external pressure and not applying external pressure to the LTO-S pouch cell is not a difference resulting from merely performance impacts on the LTO anode. Rather, any demonstrated performance difference necessarily results from an impact on the sulfur cathode 102. FIG. 6B illustrates that, with application of external pressure (namely, about 172 kPa (about 25 psi)), greater specific capacity is exhibited at the later cycles than compared to the same later cycles of the LTO-S pouch cell without application of external pressure, which indicates that the performance of the cathode 102, itself, is improved due to the external application of pressure.

In Examples 5 to 7, below, the subject cell is in accordance with the cell 100 of FIG. 1A and FIG. 1B and the cathode 102 comprised about 64 wt. % elemental sulfur (e.g., about 99.5 wt. % sulfur), about 26 wt. % SUPER P®, and about 10 wt. % PVDP binder. To form the cathode 102, a melt-diffused carbon-sulfur mixture (e.g., slurry) was prepared by ball milling the sulfur with the SUPER P® followed by heat treatment at 155° C. in an autoclave for 12 hours. To this mixture, the PVDF binder was mixed in a 1-methyl-2-pyrrolidone (NMP) (e.g., solvent) solution with an additional NMP solvent. The resulting mixture was mixed for about 5 minutes and was then coated on 20 μm carbon-coated aluminum current foil (e.g., cathode support material 108) and dried in a furnace with dry air flow at 80° C. for 3 days. The resultant cathodes 102 included about 3 mg/cm² of active sulfur weight with a porosity in a range from 80 vol. % to 90 vol. % (e.g., non-calendared). Some of these cathodes 102 were calendared to 50 vol. % porosity. The non-calendared and calendared cathodes 102 were used as the cathode 102 of the cell 100 (FIG. 1A and FIG. 1B). The practical capacity for 1 C of this sulfur is defined as 1000 mAh/g (3 mAh/cm²).

The pouch 120 (FIG. 1A, FIG. 3A) was formed as a single layer pouch cell (43 mm×56 mm), and the cell 100 was assembled using the cathodes 102 described above. Accordingly, the cell 100 was assembled to include either a calendared (e.g., relatively less porous) cathode 102 or a non-calendared (e.g., relatively more porous) cathode 102. CELGARD® 2325, available from Celgard, LLC, of Charlotte, N.C., USA, was used as the separator 106, and an electrolyte-to-sulfur ratio was 15 μL/mg of 1M lithium bis(trifluoromethanesulfonyl)imide (LiTFSI) and 2 wt. % of lithium nitrate (LiNO₃) mixed in 1:1 DOL:DME (1,3-dioxolane (DOL) and dimethoxyethane (DME)).

For Examples 5 and 6, lithium metal (30 μm thickness) was used as the anode 104.

For Example 7, pre-lithiated Li₄Ti₅O₁₂ (LTO) functioned as the anode 104, and the cathode 102 was the above-described calendared cathode. For these LTO-S cells, active sulfur loading was adjusted to the capacity of pre-lithiated LTO electrodes.

For Examples 5 through 7, the temperature of the cells 100 was maintained at 25° C.±1° C. in an environmentally controlled chamber.

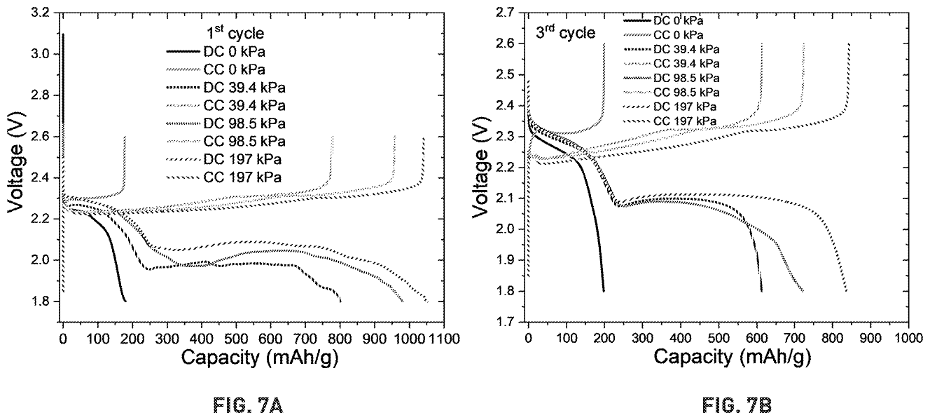

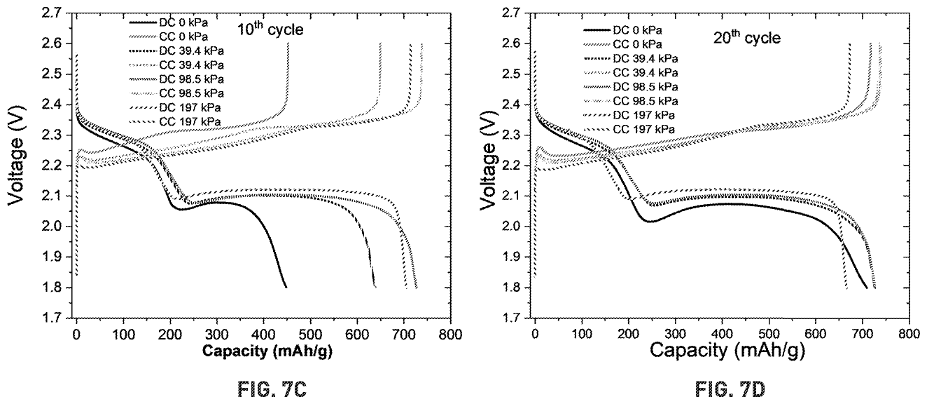

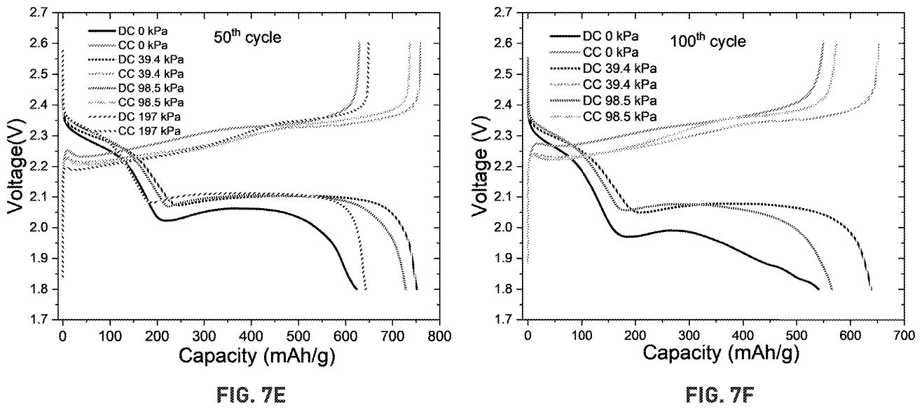

Example 5: FIG. 7A through FIG. 7F plot—at various charge/discharge cycles (i.e., 1^{st} cycle in FIG. 7A, 3^{rd} cycle in FIG. 7B, 10^{th} cycle in FIG. 7C, 20^{th} cycle in FIG. 7D, 50^{th} cycle in FIG. 7E, and 100^{th} cycle in FIG. 7F)—voltage versus discharge capacity (“DC”) and charge capacity (“CC”) for the cells 100 (FIG. 1A), made with the non-calendared (80 vol. % to 90 vol. % porosity) cathode 102, at various externally-applied pressures: 0 kPa, 39.4 kPa, 98.5 kPa, and 197 kPa. It was observed that the total capacity (below 20 cycles) was low at no externally-applied pressure (the 0 kPa), which is contemplated to be due to wetting of the cathode 102 because of the relatively higher porosity of the cathode 102 and an inability of the electrolyte to access the active sulfur. With increasing pressure, the accessible capacity increased, which is contemplated to be due to a reduction in thickness/porosity, which heled the electrolyte access active material. Charge transfer resistance decreased with increased pressure, reducing the reaction resistance of the cell 100. No wetting issue was observed at 197 kPa, which further confirms that the electrode (e.g., cathode 102) thickness and porosity improved with increased pressure in order to access most of the active sulfur in the cathode 102 during the first discharge. The pressure had a positive effect on the cell 100 electrochemical performance, but pressure variation related to cathode volume change during discharge/charge was not observed. This is contemplated to be because the relatively high porosity of the cathode 102 accommodated sulfur volume changes and higher volume changes associated with Li metal stripping and plating, which masked the cathode volume change (pressure) response.

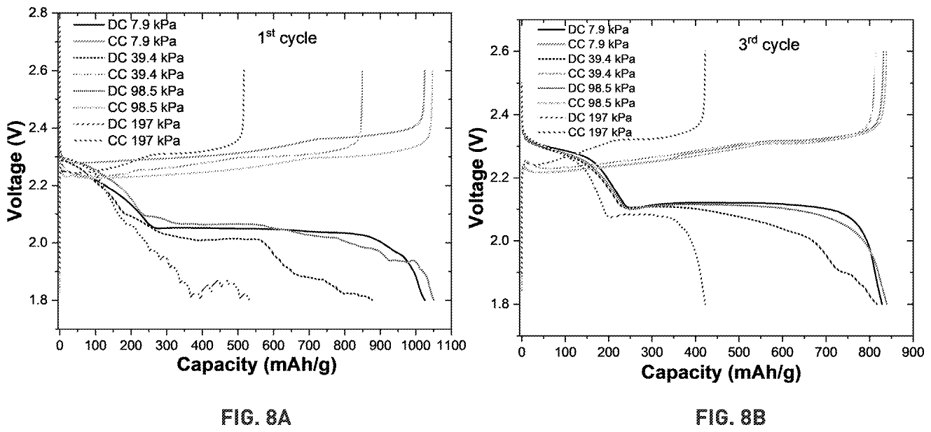

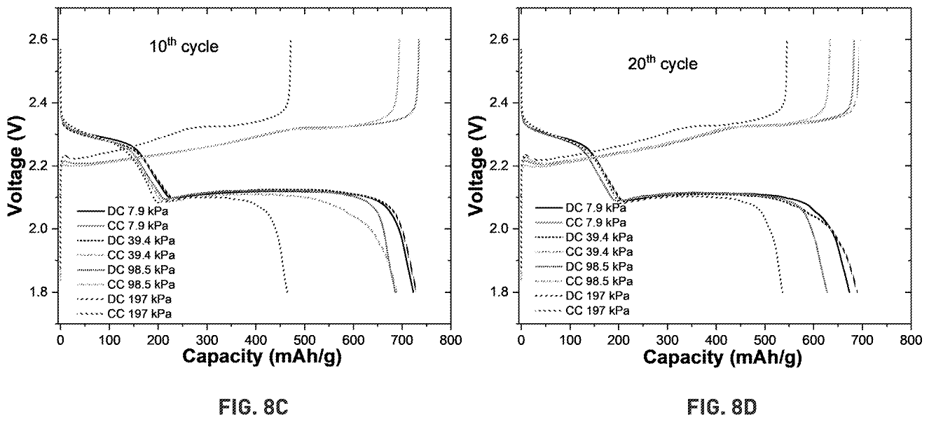

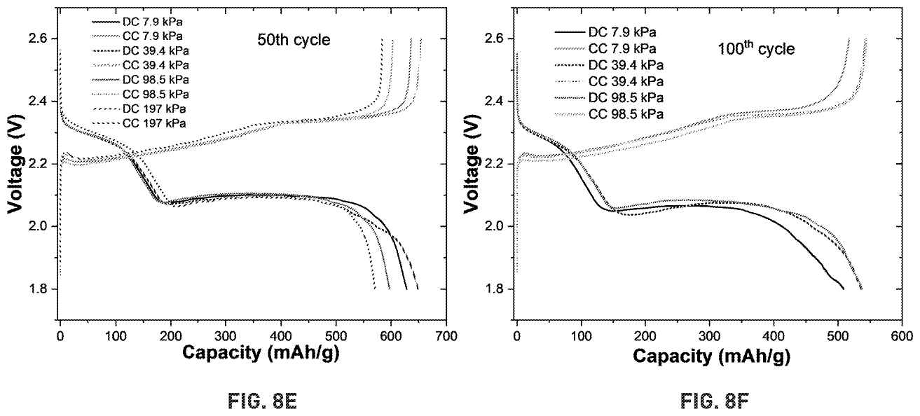

Example 6: FIG. 8A through FIG. 8F plot—at various charge/discharge cycles (i.e., 1^{st} cycle in FIG. 8A, 3^{rd} cycle in FIG. 8B, 10^{th} cycle in FIG. 8C, 20^{th} cycle in FIG. 8D, 50^{th} cycle in FIG. 8E, and 100^{th} cycle in FIG. 8F)—voltage versus discharge capacity (“DC”) and charge capacity (“CC”) for the cells 100 (FIG. 1A), made with the calendared (50 vol. % porosity) cathode 102, at various externally-applied pressures: 7.9 kPa, 39.4 kPa, 98.5 kPa, and 197 kPa. The initial accessible capacity increased with pressure, but the cell 100 at 39.4 kPa pressure had capacity retention moderately better than at 98.5 kPa up to 90 cycles. After 90 cycles, the cell 100 with 98.5 kPa applied pressure performed better than the cell 100 with 7.8 kPa and 39.4 kPa applied pressure. For the cell with 197 kPa applied pressure, the formation capacity was much lower than with 7.8 kPa, 39.4 kPa, and 98.5 kPa, which is contemplated to be due to a wetting issue. Without being bound by any theory, the wetting issue at the 197 kPa applied pressure in cells 100 with calendared cathodes 102 may be explained by the reduced porosity with increased pressure and inability of the electrolyte to access all the active sulfur, resulting in low initial capacity.

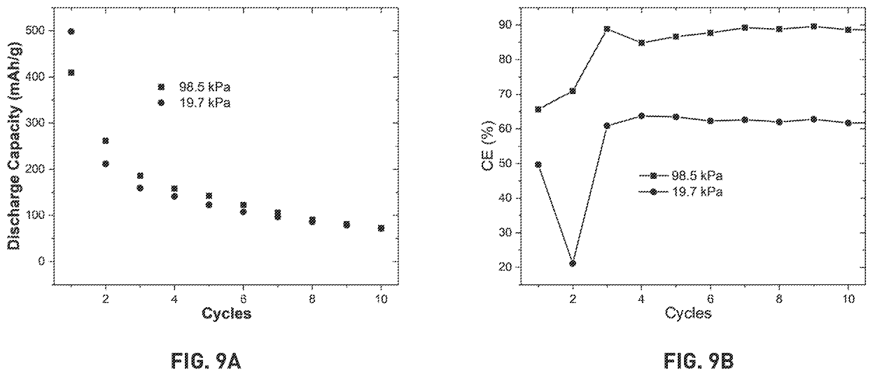

Example 7: To better understand the role of pressure on the cathode 102, without masking by metal volume/pressure variation in the anode 104, the Li anode 102 (e.g., used in Examples 5 and 6) was replaced with a 0.1% volume expanded anode 104 of lithiated Li₄Ti₅O₁₂ (LTO). These anodes 104 were tested with calendared (50 vol. % porosity) cathodes 104 at 19.7 kPa and 98.5 kPa of externally-applied pressure. FIG. 9A shows the discharge capacity versus cycle at the two applied pressure levels. FIG. 9B shows the Coulombic efficiency (CE) versus cycle at the two applied pressure levels. The higher CE at 98.5 kPa, compared to at 19.7 kPa, confirmed that increased pressure had a positive effect on the cathode 102 during cycling. Without being bound by any theory, it is believed that the lower CE at the lower pressure (the 19.7 kPa) was associated with polysulfides leaking (sulfide heave) from the cathode 102 and migrating to the anode 104; whereas, at the higher pressure (98.5 kPa), the sulfide heave effect was minimized, achieving higher CE.

From Examples 5 through 7, it was confirmed that externally applied pressure improved cycling performance. Tailored porosity (e.g., calendaring or non-calendaring) also apparently enabled improved cycling performance. The cells 100 including calendared (50 vol. % porosity) cathodes 102 (e.g., of Example 6) had less Li-metal evaluation and corrosion compared with cells 100 including non-calendared (80 vol. % to 90 vol. % porosity) cathodes 102 (e.g., of Example 5) and further improved cycling performance up to 98.5 kPa. Increasing pressure beyond 98.5 kPa with the calendared (50 vol. % porosity) cells 100 apparently negatively impacted performance. With the non-calendared (80 vol. % to 90 vol. % porosity) cathodes 102, low, moderate, and high pressure (e.g., pressure within a range from greater than about 0 kPa to about 197 kPa) all positively impacted cell 100 performance. Accordingly, it is contemplated that both adjusted porosity of the cathode 102 and adjusted applied pressure may help to achieve better electrochemical performance of the cell 100.

Non-limiting, example embodiments may include the following, alone or in combination:

Embodiment 1: A method of operating an energy storage device, the method comprising: during at least one of charging and discharging of an electrochemical cell of an energy storage device, applying external pressure onto the electrochemical cell, the electrochemical cell comprising a sulfur-based cathode within a compressible vessel.

Embodiment 2: The method of Embodiment 1, wherein applying the external pressure onto the electrochemical cell comprises disposing the compressible vessel between plates and moving at least one of the plates toward another of the plates to at least partially compress the compressible vessel between the plates.

Embodiment 3: The method of Embodiment 2, wherein applying the external pressure onto the electrochemical cell comprises, after moving the at least one of the plates toward the another of the plates and before the at least one of charging and discharging of the electrochemical cell, fixing a distance between the plates.

Embodiment 4: The method of Embodiment 3, further comprising maintaining the distance between the plates during the at least one of the charging and the discharging.

Embodiment 5: The method of any one of Embodiments 1 through 4, wherein applying the external pressure onto the electrochemical cell comprises applying an external pressure within a range from greater than about 0 kPa (about 0 psi) to about 689 kPa (about 100 psi) above ambient pressure.

Embodiment 6: The method of any one of Embodiments 1 through 4, wherein the sulfur-based cathode has a porosity of less than about 60 vol. % and applying the external pressure onto the electrochemical cell comprises applying an external pressure within a range from about 7.8 kPa (about 1.1 psi) to about 98.5 kPa (about 14.3 psi) above ambient pressure prior to the at least one of the charging and the discharging of the electrochemical cell.

Embodiment 7: The method of any one of Embodiments 1 through 4, wherein the sulfur-based cathode has a porosity of at least about 80 vol. % and applying the external pressure onto the electrochemical cell comprises applying an external pressure within a range from about 7.8 kPa (about 1.1 psi) to about 197 kPa (about 28.6 psi) above ambient pressure prior to the at least one of the charging and the discharging of the electrochemical cell.

Embodiment 8: An energy storage system, comprising: at least one electrochemical cell, the at least one electrochemical cell comprising, within a compressible vessel: a cathode comprising a sulfur-based active material; an anode; a separator between the cathode and the anode; and an electrolyte; and plates configured to be fixed at a distance separating a first plate of the plates from a second plate of the plates with the at least one electrochemical cell between the first plate and the second plate to compress the compressible vessel.

Embodiment 9: The energy storage system of Embodiment 8, wherein: the sulfur-based active material consists substantially of elemental sulfur (S); and the cathode further comprises at least one host material supporting the sulfur-based active material.

Embodiment 10: The energy storage system of Embodiment 8, further comprising carbon.

Embodiment 11: The energy storage system of Embodiment 8, wherein the sulfur-based active material comprises sulfurized polyacrylonitrile (SPAN) comprising sulfur bonded to carbon.

Embodiment 12: The energy storage system of any one of Embodiments 8 through 11, wherein the cathode further comprises a superconductive species.

Embodiment 13: The energy storage system of Embodiment 8, wherein the cathode further comprises at least one binder and at least one electrically-conductive host material, wherein: the sulfur-based active material comprises about 60 wt. % of the cathode; the at least one electrically-conductive host material comprises about 30 wt. % of the cathode; and the at least one binder comprises about 10 wt. % of the cathode.

Embodiment 14: The energy storage system of Embodiment 13, wherein: the at least one electrically-conductive host material comprises a conductive nanocarbon material; and the at least one binder comprises polyvinylidene fluoride (PVDF).

Embodiment 15: The energy storage system of Embodiment 8, wherein the cathode further comprises at least one binder and at least one electrically-conductive host material, wherein: the sulfur-based active material comprises sulfurized polyacrylonitrile (SPAN), the SPAN comprising about 80 wt. % of the cathode; the at least one electrically-conductive host material comprises about 10 wt. % of the cathode; and the at least one binder comprises about 10 wt. % of the cathode.

Embodiment 16: The energy storage system of any one of Embodiments 8 through 15, further comprising, within the compressible vessel, a reference electrode between the separator and an additional separator.

Embodiment 17: The energy storage system of any one of Embodiments 8 through 15, wherein the cathode has a porosity of less than about 60 vol. %.

Embodiment 18: The energy storage system of any one of Embodiments 8 through 15, wherein the cathode has a porosity of at least about 80%.

Embodiment 19: A method of assembling the energy storage system of Embodiment 8, the method comprising: disposing, between a pair of the plates and adjacent at least one pressure sensor, the at least one electrochemical cell; fixing the distance between the pair of plates at which a pressure measured by the at least one pressure sensor is within a range from greater than about 0 kPa (about 0 psi) to about 689 kPa (about 100 psi) above ambient pressure; and while maintaining the pair of the plates at the distance, charging or discharging the at least one electrochemical cell.

Embodiment 20: The method of Embodiment 19, wherein fixing the distance comprises: fixing the distance between the pair of plates at which the pressure measured by the at least one pressure sensor is within a range from about 6.9 kPa (about 1.0 psi) to about 197 kPa (28.6 psi), the cathode exhibiting a porosity of greater than about 80 vol. %; or fixing the distance between the pair of plates at which the pressure measured by the at least one pressure sensor is within a range from about 6.9 kPa (about 1.0 psi) to about 98.5 kPa (about 14.3 psi), the cathode exhibiting a porosity of less than about 60 vol. %.

While the disclosed methods, structures (e.g., cathodes), apparatus (e.g., cells), and systems are susceptible to various modifications and alternative forms in implementation thereof, specific embodiments have been shown by way of example in the drawings and have been described in detail herein. However, the disclosure is not intended to be limited to the particular forms disclosed. Rather, the disclosure encompasses all modifications, combinations, equivalents, variations, and alternatives falling within the scope of the disclosure as defined by the following appended claims and their legal equivalents.

1. A method of operating an energy storage device, the method comprising:
during at least one of charging and discharging of an electrochemical cell of an energy storage device, applying external pressure onto the electrochemical cell, the electrochemical cell comprising a sulfur-based cathode within a compressible vessel.

2. The method of claim 1, wherein applying the external pressure onto the electrochemical cell comprises disposing the compressible vessel between plates and moving at least one of the plates toward another of the plates to at least partially compress the compressible vessel between the plates.

3. The method of claim 2, wherein applying the external pressure onto the electrochemical cell comprises, after moving the at least one of the plates toward the another of the plates and before the at least one of charging and discharging of the electrochemical cell, fixing a distance between the plates.

4. The method of claim 3, further comprising maintaining the distance between the plates during the at least one of the charging and the discharging.

5. The method of claim 1, wherein applying the external pressure onto the electrochemical cell comprises applying an external pressure within a range from greater than about 0 kPa (about 0 psi) to about 689 kPa (about 100 psi) above ambient pressure.

6. The method of claim 1, wherein the sulfur-based cathode has a porosity of less than about 60 vol. % and applying the external pressure onto the electrochemical cell comprises applying an external pressure within a range from about 7.8 kPa (about 1.1 psi) to about 98.5 kPa (about 14.3 psi) above ambient pressure prior to the at least one of the charging and the discharging of the electrochemical cell.

7. The method of claim 1, wherein the sulfur-based cathode has a porosity of at least about 80 vol. % and applying the external pressure onto the electrochemical cell comprises applying an external pressure within a range from about 7.8 kPa (about 1.1 psi) to about 197 kPa (about 28.6 psi) above ambient pressure prior to the at least one of the charging and the discharging of the electrochemical cell.

8. An energy storage system, comprising:
at least one electrochemical cell, the at least one electrochemical cell comprising, within a compressible vessel:
a cathode comprising a sulfur-based active material;
an anode;
a separator between the cathode and the anode; and
an electrolyte; and
plates configured to be fixed at a distance separating a first plate of the plates from a second plate of the plates with the at least one electrochemical cell between the first plate and the second plate to compress the compressible vessel.

9. The energy storage system of claim 8, wherein:
the sulfur-based active material consists substantially of elemental sulfur (S); and
the cathode further comprises at least one host material supporting the sulfur-based active material.

10. The energy storage system of claim 8, further comprising carbon.

11. The energy storage system of claim 8, wherein the sulfur-based active material comprises sulfurized polyacrylonitrile (SPAN) comprising sulfur bonded to carbon.

12. The energy storage system of claim 8, wherein the cathode further comprises a superconductive species.

13. The energy storage system of claim 8, wherein the cathode further comprises at least one binder and at least one electrically-conductive host material, wherein:
the sulfur-based active material comprises about 60 wt. % of the cathode;
the at least one electrically-conductive host material comprises about 30 wt. % of the cathode; and
the at least one binder comprises about 10 wt. % of the cathode.

14. The energy storage system of claim 13, wherein:
the at least one electrically-conductive host material comprises a conductive nanocarbon material; and
the at least one binder comprises polyvinylidene fluoride (PVDF).

15. The energy storage system of claim 8, wherein the cathode further comprises at least one binder and at least one electrically-conductive host material, wherein:
the sulfur-based active material comprises sulfurized polyacrylonitrile (SPAN), the SPAN comprising about 80 wt. % of the cathode;
the at least one electrically-conductive host material comprises about 10 wt. % of the cathode; and
the at least one binder comprises about 10 wt. % of the cathode.

16. The energy storage system of claim 8, further comprising, within the compressible vessel, a reference electrode between the separator and an additional separator.

17. The energy storage system of claim 8, wherein the cathode has a porosity of less than about 60 vol. %.

18. The energy storage system of claim 8, wherein the cathode has a porosity of at least about 80%.

19. A method of assembling an energy storage system, the method comprising:
disposing, between a pair of plates and adjacent at least one pressure sensor, at least one electrochemical cell, the at least one electrochemical cell comprising, within a compressible vessel;
a cathode comprising a sulfur-based active material;
an anode;
a separator between the cathode and the anode; and
an electrolyte,
the plates configured to be fixed at the distance separating a first plate of the pair of plates from a second plate of the pair of plates with the at least one electrochemical cell between the first plate and the second plate to compress the compressible vessel; and
fixing the distance between the pair of plates at which a pressure measured by the at least one pressure sensor is within a range from greater than about 0 kPa (about 0 psi) to about 689 kPa (about 100 psi) above ambient pressure; and
while maintaining the pair of the plates at the distance, charging or discharging the at least one electrochemical cell.

20. The method of claim 19, wherein fixing the distance comprises:
fixing the distance between the pair of plates at which the pressure measured by the at least one pressure sensor is within a range from about 6.9 kPa (about 1.0 psi) to about 197 kPa (about 28.6 psi), the cathode exhibiting a porosity of greater than about 80 vol. %; or
fixing the distance between the pair of plates at which the pressure measured by the at least one pressure sensor is within a range from about 6.9 kPa (about 1.0 psi) to about 98.5 kPa (about 14.3 psi), the cathode exhibiting a porosity of less than about 60 vol. %.
